(19) United States
(12) Patent Application Publication
(10) Pub. No.: US 2008/0030145 A1
(43) Pub. Date: Feb. 7, 2008

(54) High-Frequency and High-Voltage Supply Unit with Retroactive Control

(75) Inventors: Gianfranco Nadalutti, Moimacco (IT); Massimo Gritti, Renon (IT)

Correspondence Address: JACOBSON HOLMAN PLLC, 400 SEVENTH STREET N.W., SUITE 600, WASHINGTON, DC, 20004, US

(73) Assignee: STERN LASER S.R.L., APPIANO (IT)

(21) Appl. No.: 11/631,871

(22) PCT Filed: Jul. 6, 2005
(86) PCT No.: PCT/IB05/01909

§ 371 Date: Jan. 8, 2007

(30) Foreign Application Priority Data
Jul. 7, 2004 (IT) BZ 2004 A 000031

(51) Int. Cl. H05B 41/24

(52) U.S. Cl. 315/268

(57) ABSTRACT

A high-frequency and high-voltage supply unit with feedback control is disclosed.

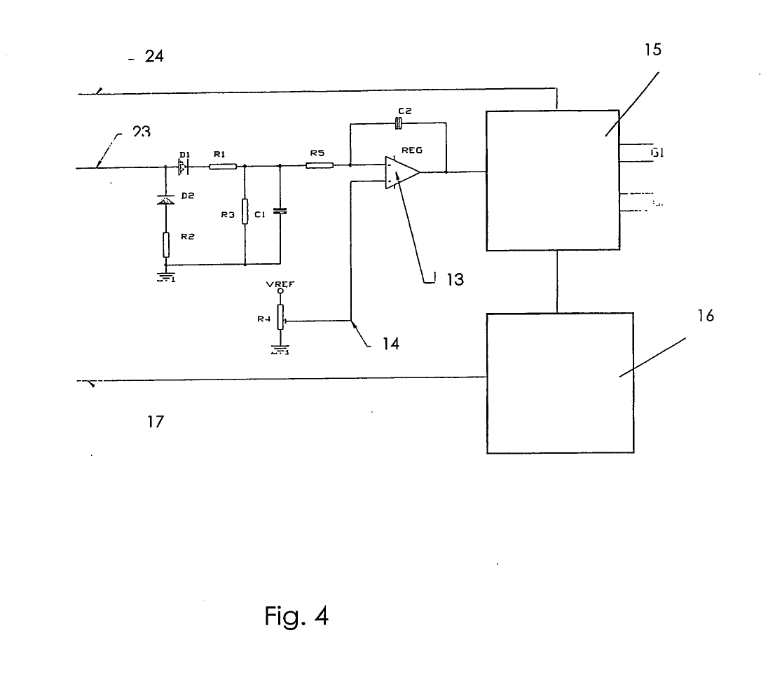

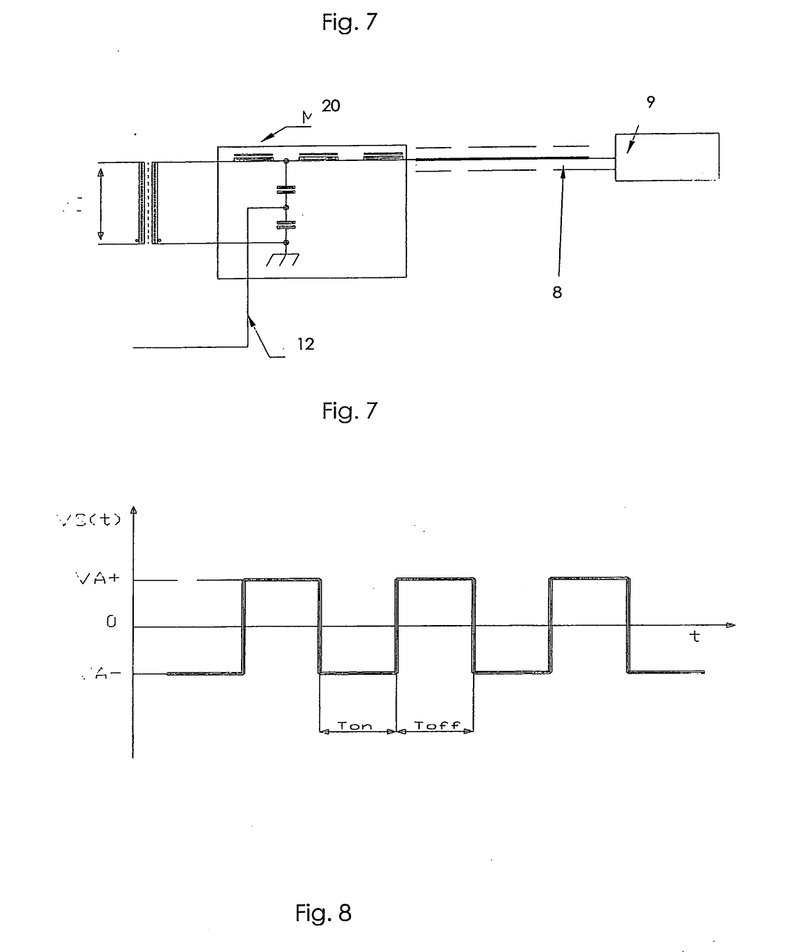

According to the invention the supply unit comprises a control module (FIG. 4) and a switching module (FIG. 6) that is able to generate a type of square wave with constant amplitude and variable frequency (FIG. 8) that operates a resonant module (FIG. 7) that in turn consists of a non-boosting insulation transformer, of an inductive module and of a coaxial connecting cable of the lamp, the coaxial cable being an active element of the resonant module.

The present invention refers to a high-frequency and high-voltage supply unit with feedback control, according to the classifying part of claim 1.

### PRIOR ART

The suppliable excimer lamp is electrically equivalent to the circuits in FIG. 1 with, when the lamp is lighted, R values of 500 ohm to 3500 ohm and C values of 40 pF to 240 pF. When the lamp is switched off the C values are 20 pF to 65 pF.

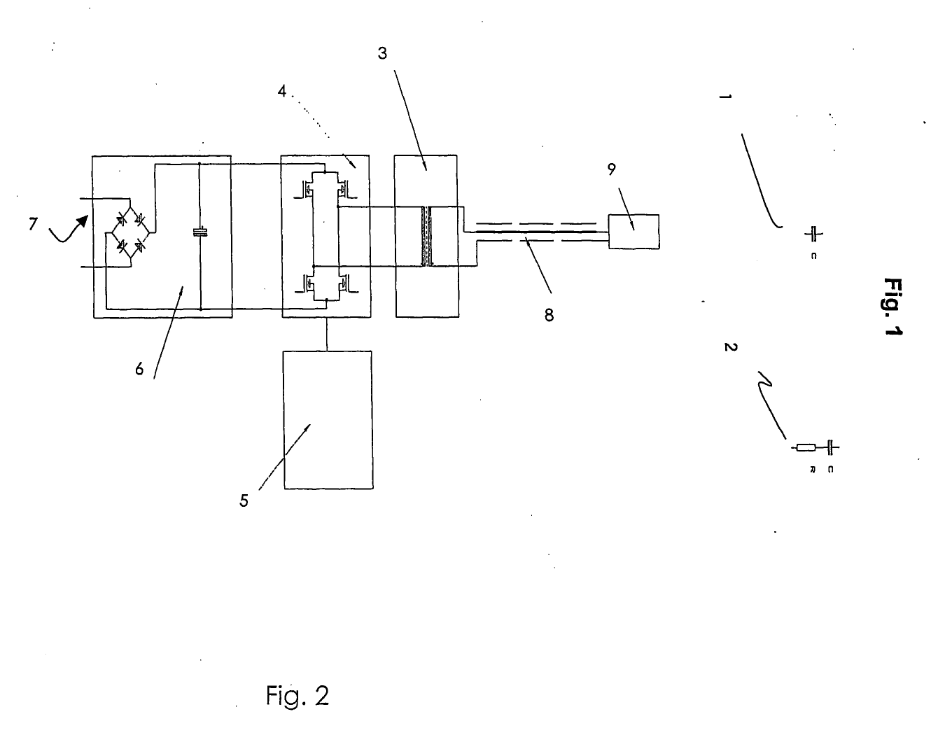

The prior-art supply, as in FIG. 2, consists of an insulation transformer and voltage booster and is able to provide non-sinusoidal voltage in the 4 KV to 14 KV peak-to-peak range and frequency from 200 KHz to 400 KHz.

The transformer is piloted by a switching module, normally in the double-bridge configuration, as in FIG. 2.

The switching module is in turn piloted by a control unit, as in FIG. 2.

The switching module is supplied by a rectifying and levelling module for rectifying and levelling the main network voltage with manually selected input and absorption with a power factor below 0.8, as in FIG. 2.

### Drawbacks of the Prior Art

The voltage-booster transformer, in order to be able to bear the stress due to the peak-to-peak 4 KV to 14 KV voltage, has to be dimensioned with particular attention to functional insulation and to safety.

In order for the voltage-booster transformer to be able to bear the stress due to the 200 KHz to 400 KHz frequency at the same time as the 4 KV to 14 KV voltage, the voltage-booster transformer must be dimensioned with particular attention paid to reducing the capacities distributed on the secondary winding. The distributed capacities of the transformer and of the connecting cable connected to the lamp make the switching module load heavy, making excess dimensioning necessary to cope with the parasite elements that are due to the construction.

The volumetric dimensions of prior-art supply units with the same features are an order of magnitude greater than those of the proposed invention.

The weight of prior-art supply units with the same features is four times greater than that of the proposed invention.

The object of the present invention is therefore to overcome the drawbacks of the prior art and to propose a highly resistant supply unit that is safe, extremely insulated and has reduced dimensions.

Solutions for overcoming drawbacks of the prior art. This and yet other objects are reached by the characterising features of claim 1.

The supply unit is suitable for supplying excimer lamps in the 4 KV to 14 KV peak-to-peak voltage range, in the 200 KHz to 400 KHz frequency range, with a sine wave in continuous service.

It has feedback with output voltage stability that is not below 3%.

It accepts a universal network input from 88 Vrms to 264 Vrms in the 50 Hz to 60 Hz frequency range and has absorption with a power factor that is not below 0.99.

It is able to supply excimer lamps in the voltage and frequency range indicated by a flexible coaxial cable so as to enable the lamp to be handled during service.

It accepts a galvanically insulated remote switch-on and switch-off control.

It communicates with an external computer and transmits the main parameters such as voltage, frequency and a sequence of diagnostic states before and during switch-on.

It has volumetric dimensions of less than 10 dm³ and weighs less than 7 kg.

The transformer has only winding insulating safety features between the secondary winding application and the primary winding main power network. It operates with voltage of the same dimensions as the network voltage.

The transformer is not a booster and has a constant coil ratio. This drastically reduces the effect of the distributed capacities and dimensioning is proportionate to the transferred nominal power.

The voltage-boost effect is obtained through a secondary resonating module consisting of a serial inductive unit and the distributed capacity of the connecting cable connected to the lamp, in addition to the lamp capacity itself.

The switching module is dimensioned for the nominal power transferred to the load.

### DESCRIPTION OF THE PROPOSED UNIT

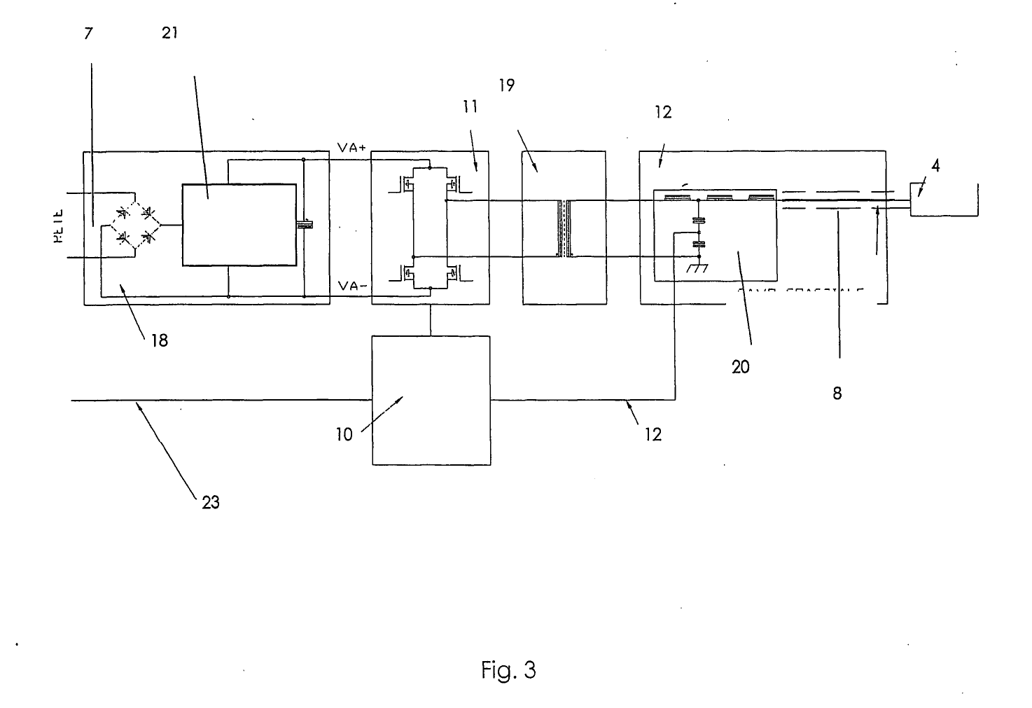

FIG. 3 shows the block diagram of the proposed unit.

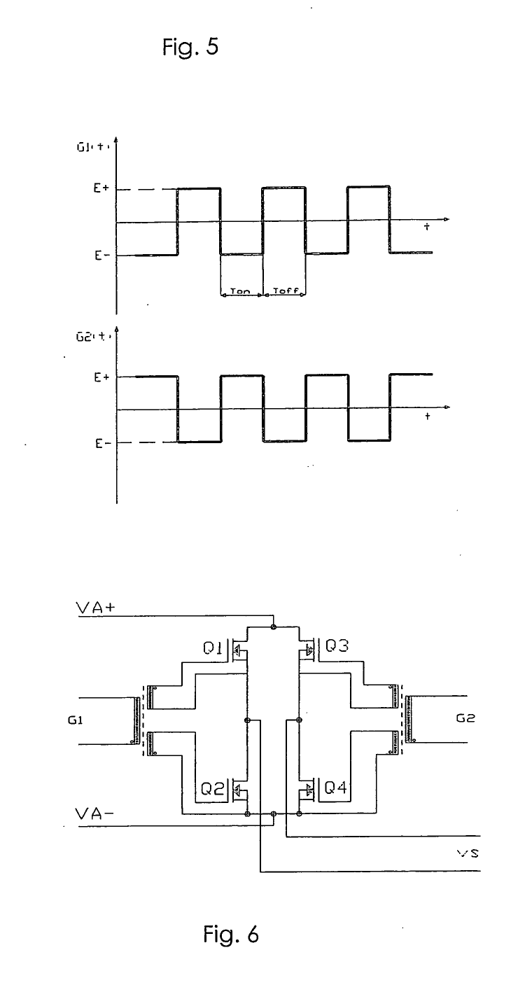

The control module in FIG. 4 generates the periodic wave shapes in FIG. 5 that are necessary for operating the switching module in FIG. 6.

The control module receives the set point from the divider R4 and the voltage feedback from the resonant module of FIG. 7. The feedback voltage, through the network of components D1, D2, R1, R2, R3 and C1 in FIG. 4, is levelled and made available to the regulator.

The analogue regulator REG in FIG. 4 processes the error between set point and feedback by supplying a voltage signal that is proportionate to the work frequency of the lamp. This signal pilots a controlled oscillator that in turn generates the signals G1 and G2 in FIG. 5 for driving the switches Q1, Q2, Q3, Q4 of the switching module in FIG. 6. The amplitude E+ and E− of the driving signals is a function of the type of switches used.

The switch-on time ratio Ton and switch-off time ratio Toff, in FIG. 5, relating to the driving waveform of the switches of the switching module, is fixed and identical.

The controlled oscillator in FIG. 4 supplies information on lamp frequency and voltage to the microcontroller in FIG. 4, which processes it and transfers it to a communication line that is accessible from the exterior.

The controlled oscillator in FIG. 4 processes a galvanically insulated external digital signal with the function of switching the lamp on or off.

The switching module in FIG. 6 operates with the shape of the square wave VS(t) in FIG. 8, with constant amplitude and variable frequency, the resonating module in FIG. 7.

The VS voltage has a zero mean value and assumes the peak values VA+ and VA− as in FIG. 8. They derive from the rectifying and levelling module of FIG. 3 that provides the switching module in FIG. 6 with a continuous supply (VA+)−(VA−), of normally approximately 400V.

The insulating transformer operates, in the secondary winding, the resonating module in FIG. 7, with the same voltage values VA+ and VA− as the primary winding.

The resonating module in FIG. 7 consists of an inductive unit that is normally insulated in a heat-dissipating resin, of the coaxial connecting cable of the lamp and of the lamp.

A basis of the invention is the fact of having used the coaxial connecting cable of the lamp as an active element of the resonating module.

The resonating module in FIG. 7 makes the lamp supply a sinusoidal supply.

From the resonating module in FIG. 7 the output voltage boost is returned through a capacitive divider that is subsequently processed by the analogue circuit in FIG. 4.

The switching module in FIG. 6 is supplied by the rectifying and levelling module in FIG. 3 that transforms the network input voltage into constant direct current.

The rectifying and levelling module in FIG. 3 absorbs a current in phase with the network input voltage and automatically rectifies the power factor.

1. A high-frequency and high-voltage supply unit with feedback control, characterised in that it comprises a control module and a switching module that is able to generate a square wave with constant amplitude and variable frequency that operates a resonant module that in turn consists of a non-boosting insulation transformer, of an inductive module and of a coaxial connecting cable connected to the lamp, the coaxial cable being an active element of the resonant module.

2. The supply unit according to claim 1 characterised in that it comprises a rectifying and levelling module with automatic adjustment of the power factor and universal network input.

3. The supply unit according to claim 1 characterised in that it comprises a rectifying and levelling module with manual selection input and without power factor adjustment.

4. The supply unit according to claim 2 characterised in that it comprises a control module with a microcontroller with diagnostic and monitoring function of the lamp features.

5. The supply unit according to claim 3 characterised in that it comprises a control module with microcontroller with diagnostic and monitoring function of the lamp features.

6. A supply unit according to claim 1, characterised in that it is suitable for supplying excimer lamps in the peak-to-peak voltage range 4 KV to 14 KV, in the 200 KHz to 400 KHz frequency range, with sine wave shape in continuous service.
